(19) United States
(12) Patent Application Publication
(10) Pub. No.: US 2017/0046674 A1
(43) Pub. Date: Feb. 16, 2017

(54) GENERATING A PAYMENT PLAN FOR PAYMENTS DUE BASED ON CHARACTERISTICS OF FUND SOURCES

(71) Applicant: International Business Machines Corporation, Armonk, NY (US)

(72) Inventors: YUCONG FENG, AUSTIN, TX (US); SU LIU, AUSTIN, TX (US); ANDREW F. LY, AUSTIN, TX (US); MICHAEL S. LY, AUSTIN, TX (US)

(21) Appl. No.: 15/043,856

(22) Filed: Feb. 15, 2016

Related U.S. Application Data
(63) Continuation of application No. 14/826,503, filed on Aug. 14, 2015.

(51) Int. Cl. G06Q 20/14; G06Q 40/06

(52) U.S. Cl. CPC G06Q 20/14; G06Q 40/06

(57) ABSTRACT

Generating payment plan for payments due includes: retrieving via a data communications network, from each of a plurality of fund sources, information describing available funds; retrieving via the data communications network, from each of a plurality of payment targets, information describing payments due within a predefined period of time; prioritizing payments due to each of the payment targets in dependence upon predefined criteria; and generating, in dependence upon the prioritized payments, the predefined criteria, and the information describing available funds, a payment plan for the predefined period, the payment plan specifying, for each payment due within the predefined period of time: a date to execute the payment; an amount of funds to apply to the payment due; and a fund source for the amount of funds to apply to the payment due.

### CROSS-REFERENCE TO RELATED APPLICATION

This application is a continuation application of and claims priority from U.S. patent application Ser. No. 14/826,503, filed on Aug. 14, 2015.

### BACKGROUND

Field of the Invention

The field of the invention is data processing, or, more specifically, methods, apparatus, and products for generating a payment plan for a plurality of payments due based on characteristics of a plurality of fund sources.

Description of Related Art

Individuals today may have many different financial-related accounts that include both fund sources and payment targets. Example fund sources may include bank accounts and credit card accounts. Example payment targets may include loan accounts, credit card accounts, savings or other bank accounts, utility accounts with regular recurring bills, and any other account which may include a regularly recurring bill payment. Each of these financial-related accounts may be have various characteristics such as annual rate of return, minimum required account balance, maximum available credit, annual percentage rate, minimum required payment, payment due date, rewards information, late payment fee, transfer fee, and so on as will occur to readers of skill in the art.

Managing many of these accounts is difficult to do efficiently and effectively. To that end, many automated systems have been introduced to reduce the amount of user input required to manage multiple financial-related accounts. At this time, these automated systems provide only provide minor analysis into the payment targets for a user. In some instances, for example, an automated system may be combine information from multiple payment targets, receive an indication from a user of a goal to ‘pay off credit cards,’ and create a specialized view of data relating to the payment targets. In this way, a user is shown his or her progress while accomplishing his or her goal. None of these automated systems, however, analyze both fund sources as well as payment targets to determine the efficient allocations of funds for bill payments. In fact, each of today's automated systems treats each fund source the same, without any regard to the various characteristics of different fund sources.

### SUMMARY

Methods, apparatus, and products for allocating funds for bill payment are disclosed in this specification. Such allocating funds for bill payment may be carried out by: retrieving via a data communications network, by a funds allocation tool from each of a plurality of fund sources, information describing available funds; retrieving via the data communications network, by the funds allocation tool from each of a plurality of payment targets, information describing payments due within a predefined period of time; prioritizing payments due to each of the payment targets in dependence upon predefined criteria; and generating, by the funds allocation tool in dependence upon the prioritized payments, the predefined criteria, and the information describing available funds, a payment plan for the predefined period, the payment plan specifying, for each payment due within the predefined period of time: a date to execute the payment; an amount of funds to apply to the payment due; and a fund source for the amount of funds to apply to the payment due.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for generating a payment plan for a plurality of payments due according to embodiments of the present invention.

FIG. 2 sets forth a functional block diagram of an example system for generating a payment plan for a plurality of payments due according to embodiments of the present invention.

FIG. 3 sets forth a flow chart illustrating an exemplary method for generating a payment plan for a plurality of payments due according to embodiments of the present invention.

FIG. 4 sets forth a flow chart illustrating a further exemplary method for generating a payment plan for a plurality of payments due according to embodiments of the present invention.

FIG. 5 sets forth a flow chart illustrating a further exemplary method for generating a payment plan for a plurality of payments due according to embodiments of the present invention.

FIG. 6 sets forth a flow chart illustrating a further exemplary method for generating a payment plan for a plurality of payments due according to embodiments of the present invention.

FIG. 7 sets forth a flow chart illustrating a further exemplary method for generating a payment plan for a plurality of payments due according to embodiments of the present invention.

FIG. 8 sets forth a flow chart illustrating a further exemplary method for generating a payment plan for a plurality of payments due according to embodiments of the present invention.

### DETAILED DESCRIPTION

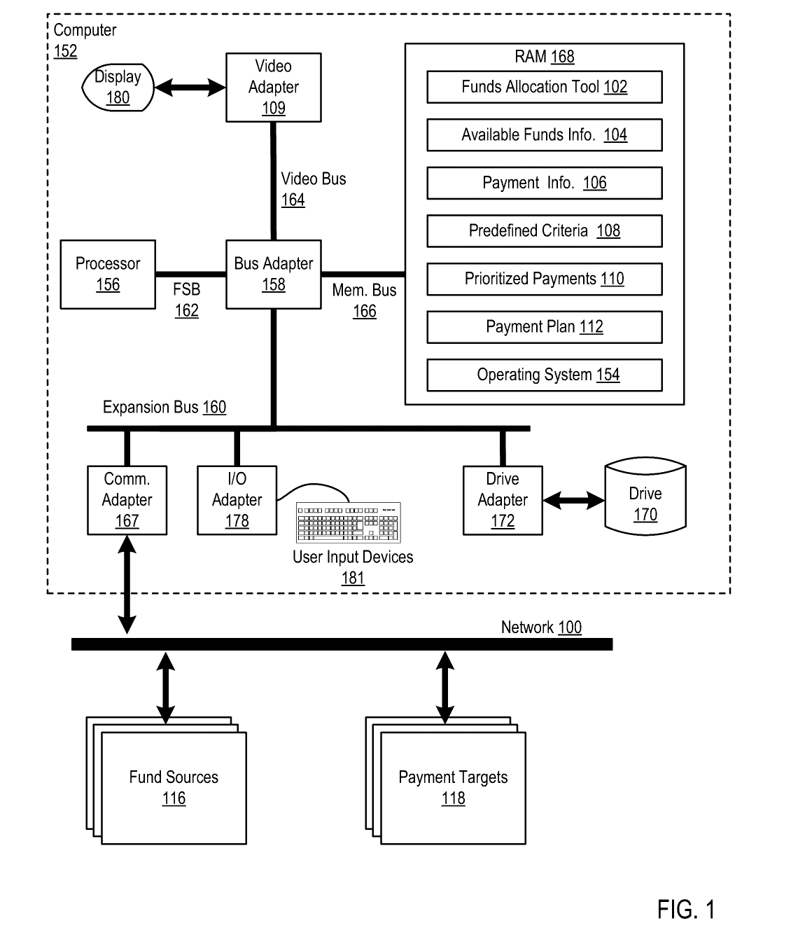

Exemplary methods, apparatus, and products for generating a payment plan for a plurality of payments due in accordance with the present invention are described with reference to the accompanying drawings, beginning with FIG. 1. FIG. 1 sets forth a network diagram of a system for generating a payment plan for a plurality of payments due according to embodiments of the present invention. The system of FIG. 1 includes an example of automated computing machinery in the form of a computer (152). The computer (152) of FIG. 1 includes at least one computer processor (156) or ‘CPU’ as well as random access memory (168) (RAM′) which is connected through a high speed memory bus (166) and bus adapter (158) to processor (156) and to other components of the computer (152).

Stored in RAM (168) is a funds allocation tool (102). The funds allocation tool (102) in the example of FIG. 1 is a module of computer program instructions that, when executed by the computer (152), causes the computer (152) to carry out payment plan generation in accordance with embodiments of the present invention. To that end, the funds allocation tool (102) may retrieve via a data communications network (100), from each of a plurality of fund sources (116), information (104) describing available funds. A ‘fund source’ as the term is used in this specification refers to the automated computing machinery of a financial institution that enables a user to effect funding of a payment by the financial institution to another party on the behalf of the user from an account associated with the user. Examples of such a financial institution account associated with a user from which funds may be sourced for payments include checking and savings accounts, credit card accounts, a line of credit, electronic currency account (such as Bitcoin), and others as will occur to readers of skill in the art.

Each such account may have various characteristics. To that end, as mentioned above, the funds allocation tool (102) retrieves from each fund source (116) information (104) describing available funds. Such information (104), at a minimum, includes an available balance which may be utilized to fund a payment. Available funds information (104), however, may also include account-specific information, such as a minimum required balance, an annual percentage yield (APY), upcoming debits or credits to the account, costs associated with making electronic transfers to fund a payment, fees associated with the funding account, rewards details, and the like. Rewards details may, for example, specify that a particular credit card account provides 6% cash back for payments to a utility company.

As explained below in more detail, the funds allocation tool (102) may retrieve such available funds information (104) from the fund sources (116), through data communications over a data communications network (100). In some embodiments, the allocation tool (102) may retrieve the information through RESTful (Representational State Transfer) API (Application Programming Interface) calls to an API exposed by the fund source. For fund sources that do not expose such an API, the funds allocation tool may data mine private (behind authentication) and public web pages of the funds sources to identify the available funds information (104) for each of the fund sources. In some embodiments, a user may also supplement the available funds information (104) manually by providing the funds allocation tool (102) information regarding funds sources that are otherwise unreachable via a typical data communications network.

The funds allocation tool (102) may also be configured to retrieve via the data communications network (100), from each of a plurality of payment targets (118), information (106) describing payments due within a predefined period of time. A ‘payment target’ as the term is used in this specification refers to the automated computing machinery of a financial institution that enables a user to effect payment of an obligation, or as context requires, the obligation itself. Such obligations may include any obligation that has a recurring payment due to satisfy the obligation. Examples of such obligations include loans, credit card bills, utility bills, loan bills, and the like. The period within which the obligation is due is referred to here as a payment due ‘within a predefined period of time.’ In some embodiments, payments due during a period of time may be all payments due for any obligation within a calendar month. In some embodiments, a payment target (118), such as a credit card account, may also be a fund source (116).

Each payment due from each payment target (118) may have various characteristics. To that end, as mentioned above, the funds allocation tool retrieves information describing the payments due within the predefined period of time for each payment target. Such information (106) describing payments due within a predefined period of time may include APR, APY, late fee information, total balance, payment due date, and the like.

The funds allocation tool (102) may also be configured to prioritize (110) payments due to each of the payment targets (118) in dependence upon predefined criteria (108). The predefined criteria (108) may specify one or more criteria to attempt to optimize in prioritizing payments to each payment targets. Examples of such criteria may include criteria to decrease the overall effect of APR or APY, criteria to maximize the effect of interest rates in fund sources, criteria to reduce or minimize fees, criteria to make payment to the payments due as quickly as possible, criteria to make payment to the payments due only on the due date for each payment due, criteria to pay equal (or nearly equal) amounts in the first half and second half of the month, prioritize payments in in ascending order of total balances, prioritize payments in descending order of total balances, criteria to maximize rewards from fund sources or payment targets, and so on. In some embodiments, there may be default criteria that the funds allocation tool (102) utilizes in the absence of user interaction and in other embodiments, a user may specify the criteria through a user interaction with graphical user interface (‘GUI’) objects within a GUI presented by the funds allocation tool to the user on a display (180).

The funds allocation tool (102) may then generate, in dependence upon the prioritized payments (110), the predefined criteria (108), and the information (104) describing available funds, a payment plan (114) for the predefined period. The payment plan (114) specifies, for each payment due within the predefined period of time: a date to execute the payment; an amount of funds to apply to the payment due; and a fund source for the amount of funds to apply to the payment due. In some embodiments, the funds allocation tool (102) may generate multiple payment plans depending on the predefined criteria (108). Consider, for example, that the predefined criteria includes both a criterion to attack the highest interest rate obligation with an additional amount of funds exceeding the obligations' minimum required payment and a separate criterion to attack the lowest balance obligation with an additional amount of funds exceeding the obligations' minimum required payment. In such an example, a payment plan configured to attack high interest rates may not match a payment plan configured to attack obligations in ascending order of outstanding balance. To that end, the funds allocation tool (102) may generate multiple payment plans, one for each criterion.

Also stored in RAM (168) is an operating system (154). Operating systems useful in computers configured generating a payment plan for a plurality of payments due according to embodiments of the present invention include UNIX™, Linux, Microsoft XP™, AIX™, IBM's i5/OS™, and others as will occur to those of skill in the art. The operating system (154), funds allocation tool (104), and other data in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for generating a payment plan for a plurality of payments due according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (109), which is an example of an I/O adapter specially designed for graphic output to a display device (180) such as a display screen or computer monitor. Video adapter (109) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for generating a payment plan for a plurality of payments due according to embodiments of the present invention include modems for wired dial-up communications, Ethernet (IEEE 802.3) adapters for wired data communications, and 802.11 adapters for wireless data communications.

The arrangement of computers, servers, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

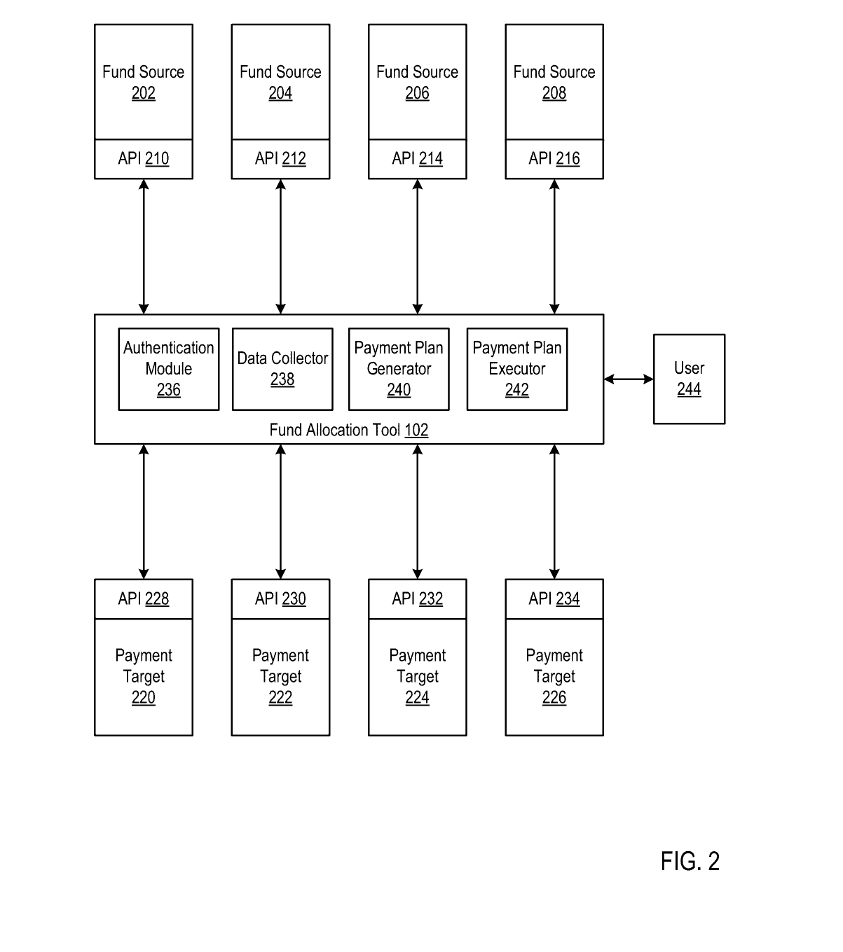

For further explanation, FIG. 2 sets forth a functional block diagram of an example system for generating a payment plan for a plurality of payments due according to embodiments of the present invention. The system of FIG. 2 includes a funds allocation tool (102) coupled for data communications to a plurality of fund sources (202, 204, 206, 208) and to a plurality of payment targets (220, 222, 224, 226). A user (244) may also be coupled for data communications to the funds allocation tool (102) through one or more user input devices.

The funds allocation tool (102) in the example of FIG. 2 includes several components including an authentication module (236), a data collector (238), a payment plan generator (240), and a payment plan executor (242). The authentication module (236) may be configured to provide authentication credentials received from the user (244) to fund sources (202, 204, 206, 208) and to payment targets (220, 222, 224, 226) for access to the fund sources' and payment targets' resources.

Once authenticated, the data collector (238) may be configured to retrieve information describing payments due within a predefined period of time from each payment target (220, 222, 224, 226) through one or more API calls. In a similar manner, the data collector (238) may retrieve information describing available funds from each fund source (202, 204, 206, 208) through one or more API calls. Although each fund source and payment target is depicted as exposing a separate API (210, 212, 214, 216, 228, 230, 232, 234), readers of skill in the art will recognize that such an API may be standardized across each of the entities.

Once the funds allocation tool (102) receives the information describing payments due and the information describing available funds, the payment plan generator (240) may prioritize payments due to each of the payment targets (220, 222, 224) in dependence upon predefined criteria. The predefined criteria may be default data, not modified by the user (244), or the predefined criteria may be specified by the user (244). The payment plan generator (240) may then generate, in dependence upon the prioritized payments, the predefined criteria, and the information describing available funds, a payment plan for the predefined period. The payment plan specifies, for each payment due within the predefined period of time: a date to execute the payment; an amount of funds to apply to the payment due; and a fund source for the amount of funds to apply to the payment due.

The payment plan executor (242) of the example funds allocation tool (102) of FIG. 2 may then execute the payment plan. In some embodiments, the payment plan executor (242) may execute the payment plan automatically without user intervention. In such an embodiment, the payment plan executor (242) may, through one or more API calls to the payment targets (220, 222, 224, 226) and for each payment due: transmit a payment instruction to the payment target of the payment due, where each payment instruction includes the amount of funds specified in the payment plan to apply to the payment due, a fund source for the amount of funds to apply to the payment due, and the date on which to apply the amount of funds to the payment.

In some embodiments, before sending such instructions, the payment plan executor (242) may present the payment plan to the user (244) for approval. The user may then provide an indication of approval of the payment plan. Responsive to receiving such an indication of approval of the payment plan, the payment plan executor (242) may execute the payment plan as described above.

Readers of skill in the art will recognize that components of the fund allocation tool (102), the fund sources, payment targets, and API in the example of FIG. 2 are for explanation only, not limitation. Such systems may include any number of fund sources and payment targets. In some embodiments a fund source may also be a payment target. In some embodiments, one or more of the fund sources or the payment targets does not expose an API and retrieving information from those sources may be carried out by the data collector performing data mining techniques on web pages provided by the payment targets and fund sources.

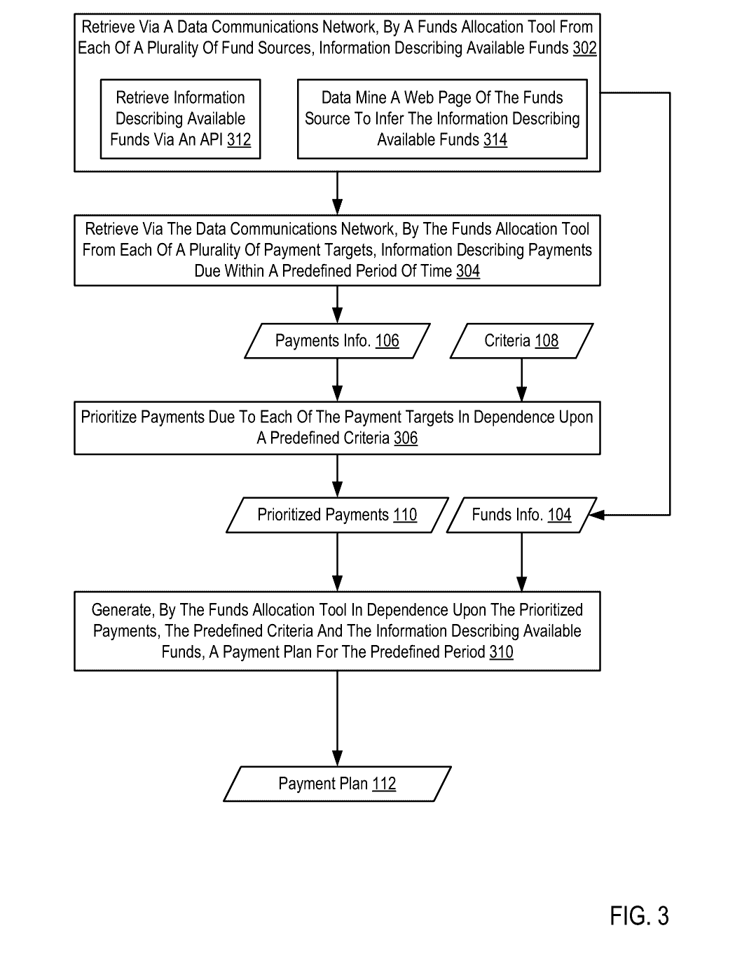

For further explanation, FIG. 3 sets forth a flow chart illustrating an exemplary method for generating a payment plan for a plurality of payments due according to embodiments of the present invention. The method of FIG. 3 may be carried out in a system similar to that set forth in the example of FIG. 1 which includes a funds allocation tool (102), payment targets (118), and fund sources (116). The method f FIG. 3 includes retrieving (302) via a data communications network, by a funds allocation tool from each of a plurality of fund sources, information describing available funds. In the method of FIG. 3, retrieving (302) information (104) describing available funds may be carried out by retrieving (312), from at least one funds source, information describing available funds via an Application Programming Interface (API′) exposed by the funds source or data mining (314) a web page of the funds source to infer the information describing available funds.

The method of FIG. 3 also includes retrieving (304) via the data communications network, by the funds allocation tool from each of a plurality of payment targets, information (106) describing payments due within a predefined period of time. Retrieving (304) such information (106) may also be carried out through an API exposed by the payment target or through data mining web pages provided by the payment target to infer the information (106).

The method of FIG. 3 also includes prioritizing (306), by the funds allocation tool, payments due to each of the payment targets in dependence upon predefined criteria. As mentioned above each predefined criterion specifies a characteristic to optimize. In this way, the funds allocation tool may order the payments due according to the characteristic specified to be optimized.

The method of FIG. 3 also includes generating (308), by the funds allocation tool in dependence upon the prioritized payments (110), the predefined criteria (108), and the information (104) describing available funds, a payment plan (112) for the predefined period. Generating (306) the payment plan (112) may be carried out by through various optimization techniques. Some such techniques are iterative in nature, iterating through multiple allocations of funds to payments due to identify at least one, but possibly a range of acceptable allocations that satisfy the predefined criterion. The payment plan specifies, for each payment due within the predefined period of time: a date to execute the payment; an amount of funds to apply to the payment due; and a fund source for the amount of funds to apply to the payment due.

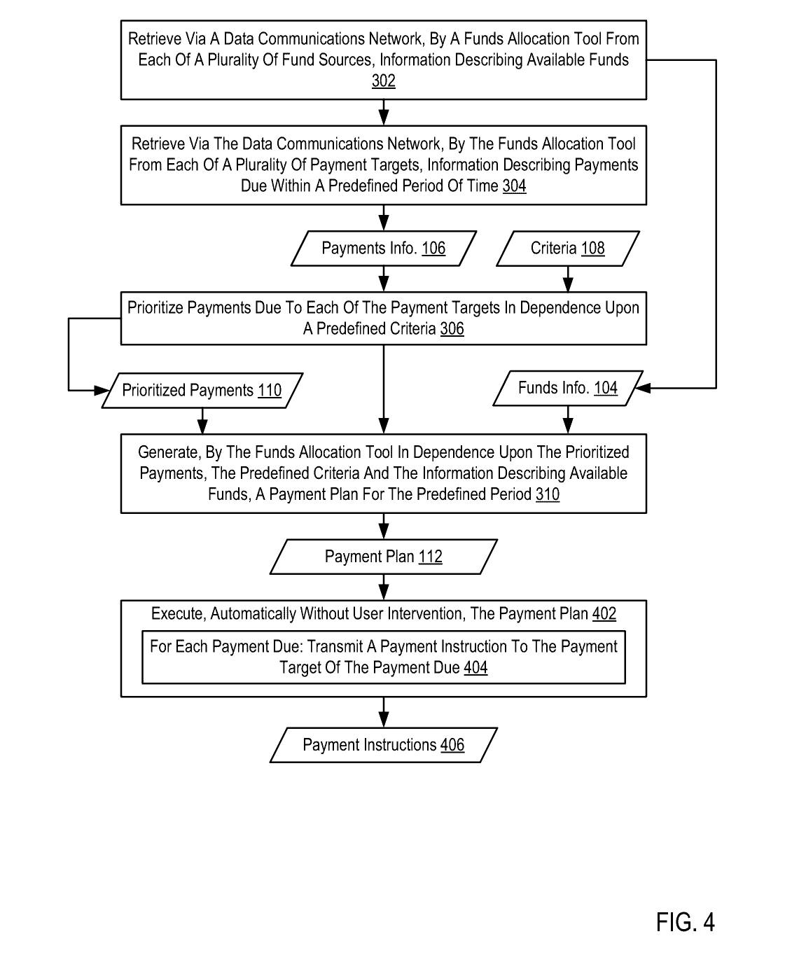

For further explanation, FIG. 4 sets forth a flow chart illustrating a further exemplary method for generating a payment plan for a plurality of payments due according to embodiments of the present invention. The method of FIG. 4 is similar to the method of FIG. 3 in that the method of FIG. 4 also includes: retrieving (302) information describing available funds; retrieving (304) information describing payments due within a predefined period of time; prioritizing (306) payments due to each of the payment targets in dependence upon predefined criteria; and generating (308) a payment plan for the predefined period of time.

The method of FIG. 4 differs from the method of FIG. 3, however, in that the method of FIG. 4 also includes executing (402), automatically without user intervention, the payment plan (112). In the method of FIG. 4, executing (402) the payment plan is carried out by transmitting (404), for each payment due, a payment instruction (406) to the payment target of the payment due. Each payment instruction (406) includes the amount of funds specified in the payment plan to apply to the payment due, a fund source for the amount of funds to apply to the payment due, and the date on which to apply the amount of funds to the payment.

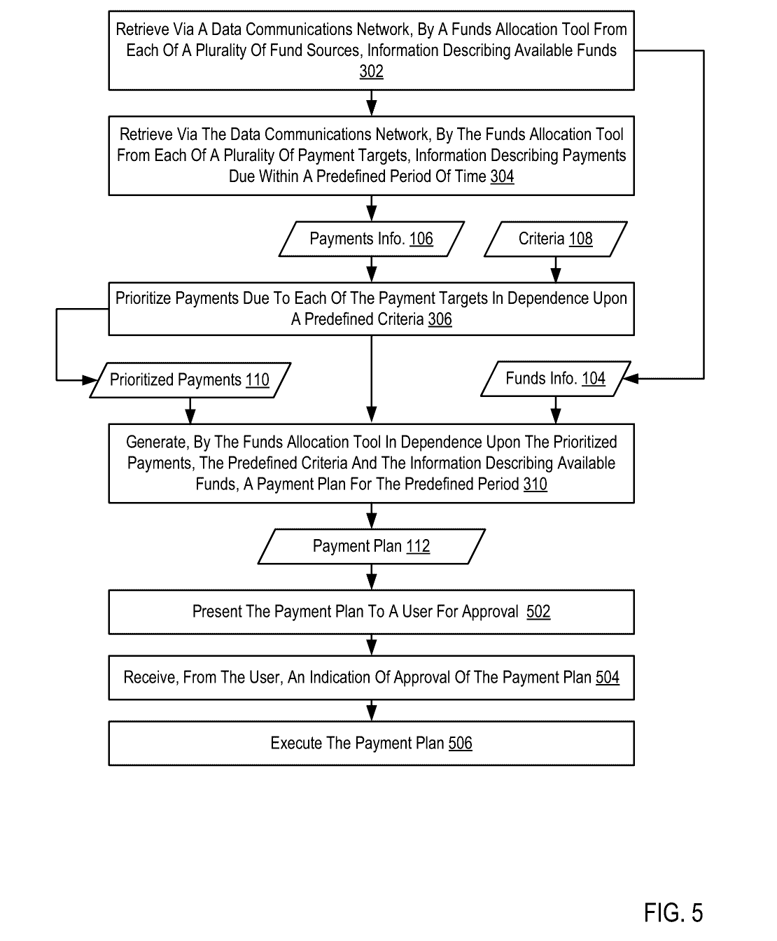

For further explanation, FIG. 5 sets forth a flow chart illustrating a further exemplary method for generating a payment plan for a plurality of payments due according to embodiments of the present invention. The method of FIG. 5 is similar to the method of FIG. 3 in that the method of FIG. 5 also includes: retrieving (302) information describing available funds; retrieving (304) information describing payments due within a predefined period of time; prioritizing (306) payments due to each of the payment targets in dependence upon predefined criteria; and generating (308) a payment plan for the predefined period of time.

The method of FIG. 5 differs from the method of FIG. 3, however, in that the method of FIG. 5 includes presenting (502) the payment plan to a user for approval. Presenting (502) the payment plan to a user for approval may include presenting the plan on a graphical user interface (‘GUI’) rendered on a computer display. In some embodiments, as mentioned above, the funds allocation tool may generate multiple different payment plans, with each plan satisfying a different predefined criterion. In such an embodiment, the method of FIG. 5 may also include presenting each of the payment plans to a user for selection of a single one of the payment plans for execution.

The method of FIG. 5 also includes receiving (504), from the user, an indication of approval of the payment plan. Receiving an indication of approval of the payment plan may be carried out by receiving user input representing user interaction with one or more objects displayed on the GUI. A GUI ‘button’ for example may be presented along with the generated payment plan with the word ‘accept’ displayed within. Upon a user clicking, via a mouse or trackpad, the accept button, the funds allocation tool may receive the indication of approval of the payment plan.

Responsive to receiving such an indication of approval, the method of FIG. 5 continues by executing (506) the payment plan. Executing (506) the payment plan may be carried out by sending a payment instruction to each payment target as described above with respect to FIG. 4.

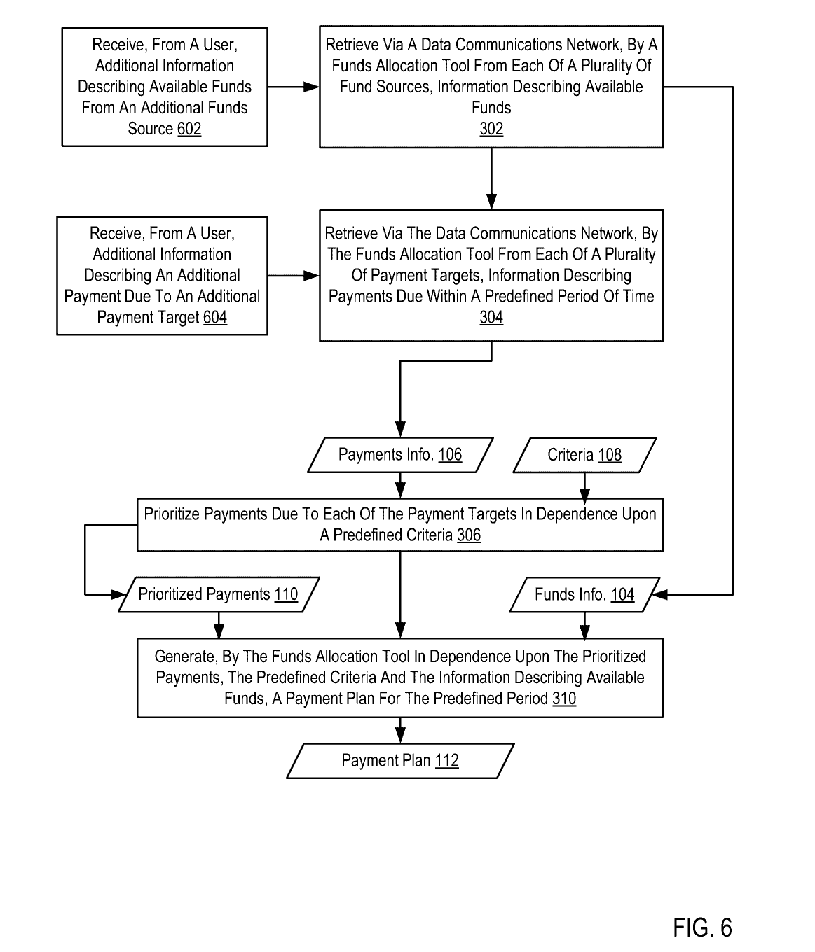

For further explanation, FIG. 6 sets forth a flow chart illustrating a further exemplary method for generating a payment plan for a plurality of payments due according to embodiments of the present invention. The method of FIG. 6 is similar to the method of FIG. 3 in that the method of FIG. 6 also includes: retrieving (302) information describing available funds; retrieving (304) information describing payments due within a predefined period of time; prioritizing (306) payments due to each of the payment targets in dependence upon predefined criteria; and generating (308) a payment plan for the predefined period of time.

The method of FIG. 6 differs from the method of FIG. 3, however, in that the method of FIG. 6 also includes receiving (602), from a user, additional information describing available funds from an additional funds source and receiving (604), from a user, additional information describing an additional payment due to an additional payment target within the predefined period of time. That is, in some embodiments, the user may provide the funds allocation tool with information that the funds allocation tool cannot obtain from a funds source or payment target. Such information may be the existence of an funds source or payment target, along with all other types of data which may be included in the information (106) describing payments due within the predefined period of time or included in the information (104) describing available funds. Said another way, the funds allocation tool may enable extensibility of fund sources and payment targets via user input.

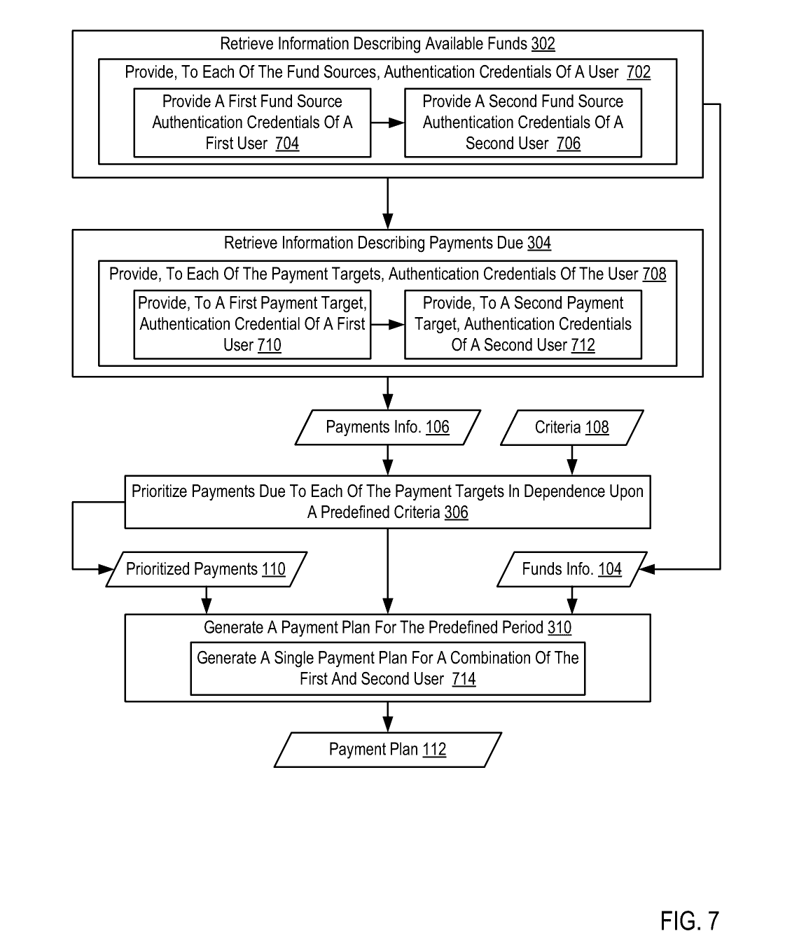

For further explanation, FIG. 7 sets forth a flow chart illustrating a further exemplary method for generating a payment plan for a plurality of payments due according to embodiments of the present invention. The method of FIG. 7 is similar to the method of FIG. 3 in that the method of FIG. 7 also includes: retrieving (302) information describing available funds; retrieving (304) information describing payments due within a predefined period of time; prioritizing (306) payments due to each of the payment targets in dependence upon predefined criteria; and generating (308) a payment plan for the predefined period of time.

The method of FIG. 7 differs from the method of FIG. 3, however, in that in the method of FIG. 7, retrieving (302), from each of a plurality of fund sources, information describing available funds includes providing (702), to each of the plurality of fund sources, authentication credentials of a user and retrieving (304), from each of a plurality of payment targets, information describing payments due within a predefined period of time includes providing (708) to each of the plurality of payment targets authentication credentials of the user.

In some embodiments, multiple users may jointly share fund sources or be jointly liable for obligations held by payment targets. To that end, providing (702) authentication credentials of a user to fund sources may include providing (704) a first fund source authentication credentials of a first user and providing (706) to a second fund source authentication credentials of a second user. In a similar manner, providing (708) authentication credentials of a user to payment targets may include providing (710), to a first payment target, authentication credential of a first user and providing (712), to a second payment target, authentication credentials of a second user. In such an embodiment in which multiple users share fund sources or obligations, generating (310) a payment plan for the predefined period may include generating (714) a single payment plan for a combination of the first and second user.

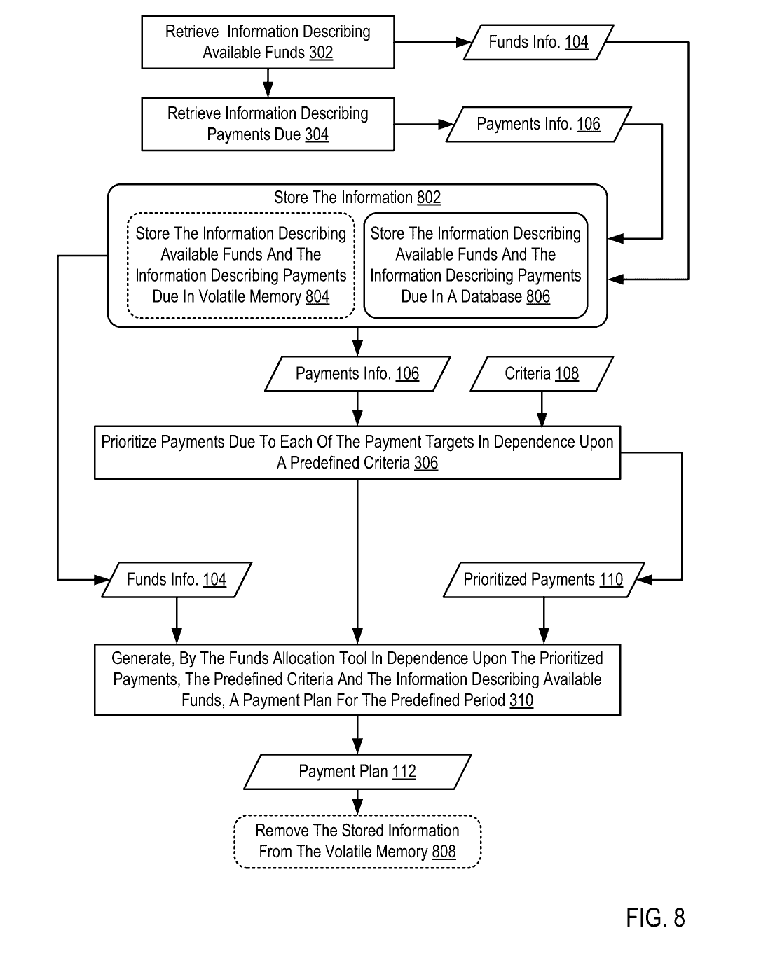

For further explanation, FIG. 8 sets forth a flow chart illustrating a further exemplary method for generating a payment plan for a plurality of payments due according to embodiments of the present invention. The method of FIG. 8 is similar to the method of FIG. 3 in that the method of FIG. 8 also includes: retrieving (302) information describing available funds; retrieving (304) information describing payments due within a predefined period of time; prioritizing (306) payments due to each of the payment targets in dependence upon predefined criteria; and generating (308) a payment plan for the predefined period of time.

The method of FIG. 8 differs from the method of FIG. 3, however, in that the method of FIG. 8 includes alternatives for storing (802) information retrieved (302, 304) from fund sources and payment targets. In one embodiment in FIG. 8, storing (802) such information may include storing (804) the information (104) describing available funds and the information (106) describing payments due in volatile memory, such as RAM. Then, after generating the payment plan, the method of FIG. 8 includes removing (808) the stored information from the volatile memory. In this way, sensitive financial data of a user may be stored securely and be ensured to be removed at the latest upon a loss of power to the volatile memory.

In another embodiment in FIG. 8, storing (802) such information may include storing (806) the information describing available funds and the information describing payments due in a database. Such a database may reduce the need to retrieve the same information in the future. Such a database may be utilized to analyze and provide historical perspective of the available funds information or payment target information.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method comprising:
retrieving via a data communications network, by a funds allocation tool from each of a plurality of fund sources, information describing available funds;
retrieving via the data communications network, by the funds allocation tool from each of a plurality of payment targets, information describing payments due within a predefined period of time;
prioritizing, by the funds allocation tool, payments due to each of the payment targets in dependence upon predefined criteria; and
generating, by the funds allocation tool in dependence upon the prioritized payments, the predefined criteria, and the information describing available funds, a payment plan for the predefined period, the payment plan specifying, for each payment due within the predefined period of time: a date to execute the payment;
an amount of funds to apply to the payment due; and a fund source for the amount of funds to apply to the payment due.

2. The method of claim 1 further comprising executing, automatically without user intervention, the payment plan including, for each payment due: transmitting a payment instruction to the payment target of the payment due, where each payment instruction includes the amount of funds specified in the payment plan to apply to the payment due, a fund source for the amount of funds to apply to the payment due, and the date on which to apply the amount of funds to the payment.

3. The method of claim 1, further comprising:
presenting the payment plan to a user for approval;
receiving, from the user, an indication of approval of the payment plan; and
executing the payment plan.

4. The method of claim 1 wherein retrieving information describing available funds further comprises retrieving, from at least one funds source, information describing available funds via an Application Programming Interface (‘API’) exposed by the funds source.

5. The method of claim 1 wherein retrieving information describing available funds further comprises data mining a web page of the funds source to infer the information describing available funds.

6. The method of claim 1 further comprising receiving, from a user, additional information describing available funds from an additional funds source.

7. The method of claim 1 further comprising receiving, from a user, additional information describing an additional payment due to an additional payment target within the predefined period of time.

8. The method of claim 1 wherein:
retrieving, from each of a plurality of fund sources, information describing available funds further comprises providing, to each of the plurality of fund sources, authentication credentials of a user; and
retrieving, from each of a plurality of payment targets, information describing payments due within a predefined period of time further comprises providing to each of the plurality of payment targets authentication credentials of the user.

9. The method of claim 8 wherein:
providing, to each of the plurality of fund sources, authentication credentials of a user further comprises providing a first fund source authentication credentials of a first user and providing to a second fund source authentication credentials of a second user;
providing, to each of the plurality of payment targets, authentication credentials of the user further comprises providing, to a first payment target, authentication credential of a first user and providing, to a second payment target, authentication credentials of a second user; and
generating a payment plan for the predefined period further comprises generating a single payment plan for a combination of the first and second user.

10. The method of claim 1, further comprising:
storing the information describing available funds and the information describing payments due in volatile memory; and
after generating the payment plan, removing the stored information from the volatile memory.

11. The method of claim 1, further comprising:
storing the information describing available funds and the information describing payments due in a database.

12. The method of claim 1, wherein at least one funds source is a payment target.

13-20. (canceled)
